(19) United States
(12) Patent Application Publication
(10) Pub. No.: US 2026/0142481 A1
(43) Pub. Date: May 21, 2026

(54) BATTERY SYSTEM

(71) Applicant: TOYOTA JIDOSHA KABUSHIKI KAISHA, Toyota-shi (JP)

(72) Inventor: Hiroyuki SAIKA, Nisshin-shi (JP)

(73) Assignee: TOYOTA JIDOSHA KABUSHIKI KAISHA, Toyota-shi (JP)

(21) Appl. No.: 19/362,937

(22) Filed: Oct. 20, 2025

(30) Foreign Application Priority Data
Nov. 18, 2024 (JP) 2024-200978

(51) Int. Cl. H02J 7/00

(52) U.S. Cl. CPC H02J 7/663; H02J 7/56; H02J 7/80

(57) ABSTRACT

A battery system that is equipped with N battery cells includes a first power line pair for exchanging direct current electric power between the battery system and an external system, a switching circuit that is disposed between the N battery cells and the first power line pair, and that is configured to switch between electrical connection and interruption with respect to the first power line pair, in increments of individual battery cells, and a control device that monitors a state of each of the N battery cells and controls the switching circuit based on monitoring results.

### CROSS-REFERENCE TO RELATED APPLICATION

This application claims priority to Japanese Patent Application No. 2024-200978 filed on November 18, 2024. The disclosure of the above-identified application, including the specification, drawings, and claims, is incorporated by reference herein in its entirety.

### BACKGROUND

### 1. Technical Field

The present disclosure relates to a battery system.

### 2. Description of Related Art

Japanese Unexamined Patent Application Publication No. 2006-238619 (JP 2006-238619 A) discloses a battery pack including a battery assembly circuit in which a plurality of series modules, each of which has a plurality of secondary battery cells connected in series, are connected in parallel, and a battery abnormality detection circuit. In this battery pack, the battery assembly circuit has a parallel connection-isolation switch that electrically isolates the parallel-connected secondary battery cells, and a battery assembly circuit isolation switch for isolating the series modules, which are isolated by the parallel connection-isolation switch, from a battery assembly circuit main unit.

The battery abnormality detection circuit detects an abnormality in the secondary battery cell based on a change in voltage of each of the secondary battery cells when the parallel connection-isolation switch is off. When an abnormal secondary battery cell is detected, the battery abnormality detection circuit then isolates the series module including the abnormal secondary battery cell from the battery assembly circuit main unit, using the battery assembly circuit isolation switch.

### SUMMARY

In the above-described battery pack, when an abnormal secondary battery cell is detected in a series module, the entire series module including the abnormal secondary battery cell is isolated from the battery assembly circuit main unit. Accordingly, there is concern that output of the entire battery assembly circuit will decrease.

The present disclosure has been made to solve the foregoing problems, and an object thereof is to provide a battery system that can switch between connection and interruption in increments of individual battery cells.

A battery system according to the present disclosure is equipped with N battery cells, in which N is an integer of 3 or more. The battery system includes a first power line pair for exchanging direct current electric power between the battery system and an external system, a switching circuit that is disposed between the N battery cells and the first power line pair, and that is configured to switch between electrical connection and interruption with respect to the first power line pair, in increments of individual battery cells, and a control device that monitors a state of each of the N battery cells and controls the switching circuit based on monitoring results.

According to the present disclosure, switching can be performed between connection and interruption in the battery system including a plurality of the battery cells, in increments of individual battery cells. This enables decrease in output of the entire battery system, due to an abnormality occurring in part of the battery cells, to be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a battery system according to a first embodiment;

FIG. 2 is a diagram illustrating an example of the configuration of a switching circuit;

FIG. 3 is a diagram illustrating operations of a switching circuit according to a modification of the first embodiment;

FIG. 4A is a diagram illustrating operations of a switching circuit according to a second embodiment;

FIG. 4B is a diagram illustrating operations of the switching circuit according to the second embodiment;

FIG. 5 is a diagram illustrating operations of a switching circuit according to a third embodiment;

FIG. 6 is a diagram illustrating operations of a switching circuit according to a fourth embodiment; and

FIG. 7 is a diagram illustrating operations of a switching circuit according to a fifth embodiment.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated.

### First Embodiment

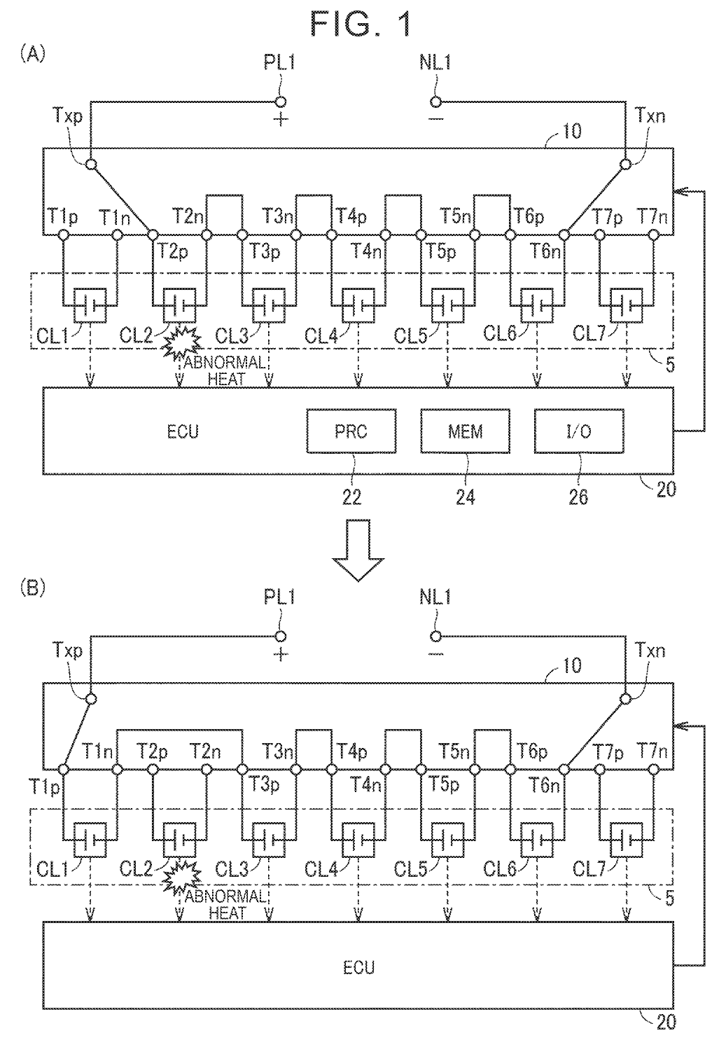

A part (A) of FIG. 1 is a diagram illustrating a schematic configuration of a battery system according to a first embodiment. As illustrated in the part (A) of FIG. 1, the battery system according to the first embodiment includes a battery pack 5, a switching circuit 10, a power line pair PL1 and NL1, and an electronic control unit (ECU) 20.

The battery pack 5 includes N (e.g., seven) battery cells (single cells) CL1 to CL7. Hereinafter, the battery cells CL1 to CL7 will also be collectively referred to as "battery cells CL". In the example of FIG. 1, the battery system includes seven battery cells CL, but it is sufficient for the number N of the battery cells CL to be any integer equal to or greater than three.

The battery cell CL is a rechargeable direct current power source (secondary battery), such as a lithium ion battery, a nickel metal hydride battery, or the like, or an electric double-layer capacitor. Each of the battery cells CL is provided with a monitoring module (omitted from illustration) for monitoring the state of the corresponding battery cell CL.

The monitoring module includes a voltage sensor that detects terminal voltage of the corresponding battery cell CL, a current sensor that detects current that is being input to and output from the corresponding battery cell CL, and a temperature sensor that detects temperature of the corresponding battery cell CL. The monitoring module outputs signals indicating detection values of these sensors to the ECU 20.

The battery system is connected to an external system, omitted from illustration, via the power line pair PL1 and NL1. The power line pair PL1 and NL1 exchanges direct current electric power between the battery pack 5 and the external system. The power line pair PL1 and NL1 is made up of a positive power line PL1 and a negative power line NL1.

The external system is, for example, a charger/discharger that is configured to be able to charge and discharge the battery pack 5, or a power control unit (PCU) of an electrified vehicle, or the like. The charger/discharger has a power converter that converts electric power that is externally supplied thereto into direct current electric power that is suitable for charging the battery pack 5, and outputs the direct current electric power that has been thus converted to the battery system via the power line pair PL1 and NL1. The charger/discharger also converts direct current electric power that is supplied from the battery system via the power line pair PL1 and NL1 into electric power that is suitable for driving a power load that is omitted from illustration, and supplies this electric power to the power load. The PCU has a power conversion device that converts electric power bidirectionally between a motor generator and the battery system of the electrified vehicle.

The switching circuit 10 is disposed between the battery pack 5 and the power line pair PL1 and NL1. The switching circuit 10 is configured to be able to switch between electrical connection and interruption with respect to the power line pair PL1 and NL1 in increments of individual battery cells CL.

Specifically, the switching circuit 10 includes a plurality of positive terminals T1p to T7p, a plurality of negative terminals T1n to T7n, a positive terminal Txp, and a negative terminal Txn. The positive terminals T1p to T7p are electrically connected to cathodes of the multiple battery cells CL1 to CL7, respectively. The negative terminals T1n to T7n are electrically connected to anodes of the battery cells CL1 to CL7, respectively. That is to say, a battery cell CLi is connected between a positive terminal Tip and a negative terminal Tin, where i is an inter of 1 or more and N or less.

The positive terminal Txp is electrically connected to the positive power line PL1. The negative terminal Txn is electrically connected to the negative power line NL1.

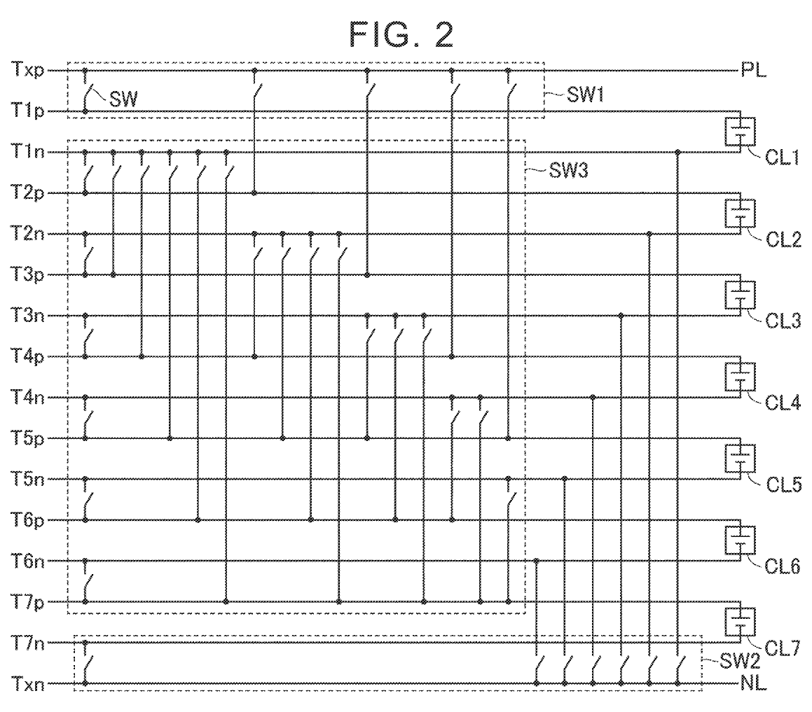

FIG. 2 is a diagram illustrating an example of the configuration of a switching circuit 10. As illustrated in FIG. 2, the switching circuit 10 includes a plurality of switches SW. The switches SW are grouped into switch groups SG1, SG2, and SG3. The switch group SG1 includes multiple switches SW that are respectively connected between the positive terminal Txp and the positive terminals T1p to T7p. The switch group SG2 includes multiple switches SW that are respectively connected between the negative terminal Txn and the negative terminals T1n to T7n. The switch group SG3 includes multiple switches SW that are connected between the positive terminal Tip that is connected to the cathode of the battery cell CLi, and the negative terminal Tjn that is connected to the anode of another battery cell CLj. The i and j are integers that are 1 or more and N or less.

Turning the multiple switches SW on and off is controlled by the ECU 20. By turning on a switch SW included in the switch group SG1, the corresponding positive terminal Tip and the positive terminal Txp are connected, and by turning off the switch SW, the corresponding positive terminal Tip and positive terminal Txp are interrupted. That is to say, by turning on and off the switches SW of the switch group SG1, electrical connection and interruption between the cathode of each of the battery cells CL and the positive power line PL1 is switched.

By turning on a switch SW that is included in the switch group SG2, the negative terminal Tin and the negative terminal Txn are connected, and by turning off the switch SW, the negative terminal Tin and the negative terminal Txn are interrupted. That is to say, by turning on and off the switches SW of the switch group SG2, electrical connection and interruption between the anode of each of the battery cells CL and the negative power line NL1 is switched.

By turning on a switch SW that is included in the switch group SG3, the positive terminal Tip and the negative terminal Tjn are connected, and by turning off the switch SW, the positive terminal Tip and the negative terminal Tjn are interrupted. That is to say, by turning on and off the switches SW of the switch group SG3, the series connection and interruption of the battery cells CLi and the battery cells CLj are switched.

The switching circuit 10 can connect the battery cells CL1 to CL7 in series and/or in parallel between the positive power line PL1 and the negative power line NL1 by turning on and off multiple switches SW. The number of serial connections of the battery cells CL between the positive power line PL1 and the negative power line NL1 can be set to any value between 2 or more and N or less, in accordance with the number N of battery cells. The number of parallel connections of the battery cells CL between the positive power line PL1 and the negative power line NL1 can be set to any value between 2 or more and N or less, in accordance with the number N of battery cells. The switching circuit 10 can also combine serial connection and parallel connection of the battery cells CL. The switching circuit 10 is also capable of connecting one battery cell CL between the positive power line PL1 and the negative power line NL1.

Returning to the part (A) of FIG. 1, the ECU 20 includes a processor 22 such as a central processing unit (CPU) or the like, memory 24 such as read only memory (ROM), random access memory (RAM), and so forth, and an input/output (I/O) circuit 26 for inputting and outputting various types of signals. The ECU 20 controls the switching circuit 10 based on signals received from the monitoring module of each of the battery cells CL, and based on maps, programs, and so forth, stored in the memory 24.

Specifically, the ECU 20 acquires the state of each of the battery cells CL (terminal voltage of battery cell CL, current input to and output from battery cell CL, temperature, State Of Charge (SOC), and internal resistance, of battery cell CL), based on signals that are received from the monitoring module of each of the battery cells CL. The ECU 20 then detects presence or absence of various types of abnormalities in each of the battery cells CL (overdischarge, deterioration abnormality, high temperature abnormality, or other such abnormalities in the battery cell CL) based on the state of each of the battery cells CL, and controls the switching circuit 10 based on detection results thereof.

For example, when all seven battery cells CL1 to CL7 are normal, as illustrated in the part (A) of FIG. 1, the ECU 20 controls the switching circuit 10 to connect M (e.g., five) battery cells CL2 to CL6 of the seven battery cells CL1 to CL7, in series. In this case, a serial circuit of five battery cells CL2 to CL6 is connected between the positive power line PL1 and the negative power line NL1.

A case will be assumed in which a high temperature abnormality occurs in this serial circuit, in which the temperature of part of the battery cells CL (e.g., battery cell CL2) exceeds an upper limit temperature. In this case, the ECU 20 controls the switching circuit 10 to electrically isolate the battery cell CL2 from the power line pair PL1 and NL1, as illustrated in a part (B) of FIG. 1.

The ECU 20 further controls the switching circuit 10 to connect an unused battery cell CL other than the battery cells CL2 to CL6 (e.g., battery cell CL1) in series with the battery cells CL3 to CL6. Accordingly, after the high temperature abnormality is detected in the battery cell CL2, a serial circuit of five battery cells CL1 and CL3 to CL6, which is the same number as the number before the high temperature abnormality was detected, is connected between the positive power line PL1 and the negative power line NL1.

In the present embodiment, the switching circuit 10 can switch between electrical connection and interruption with respect to the power line pair PL1 and NL1 in increments of individual battery cells CL, whereby the current flowing through the battery cell CL2 can be reduced to zero by isolating the battery cell CL2, in which a high temperature abnormality has occurred, from the power line pair PL1 and NL1. This enables equalizing the load on the multiple battery cells CL and extending the life of the battery pack 5 as a whole.

Note that when the temperature of the battery cell CL2 that is no longer in use drops to an appropriate temperature, the ECU 20 can control the switching circuit 10 to reconnect the battery cell CL2 in series with the battery cells CL3 to CL6. In this case, by isolating the battery cell CL1 from the power line pair PL1 and NL1, the battery cells CL1 to CL7 can be returned to their original connection state.

Also, the other normal battery cells CL3 to CL6 can continue to be used even after a high temperature abnormality has been detected, and accordingly exchange of electric power with the external system can be continued. Further, by connecting the unused battery cell CL1 in series with the battery cells CL3 to CL6 in place of the battery cell CL2 with the high temperature abnormality, the voltage of the battery pack 5 overall can be maintained.

### Modifications

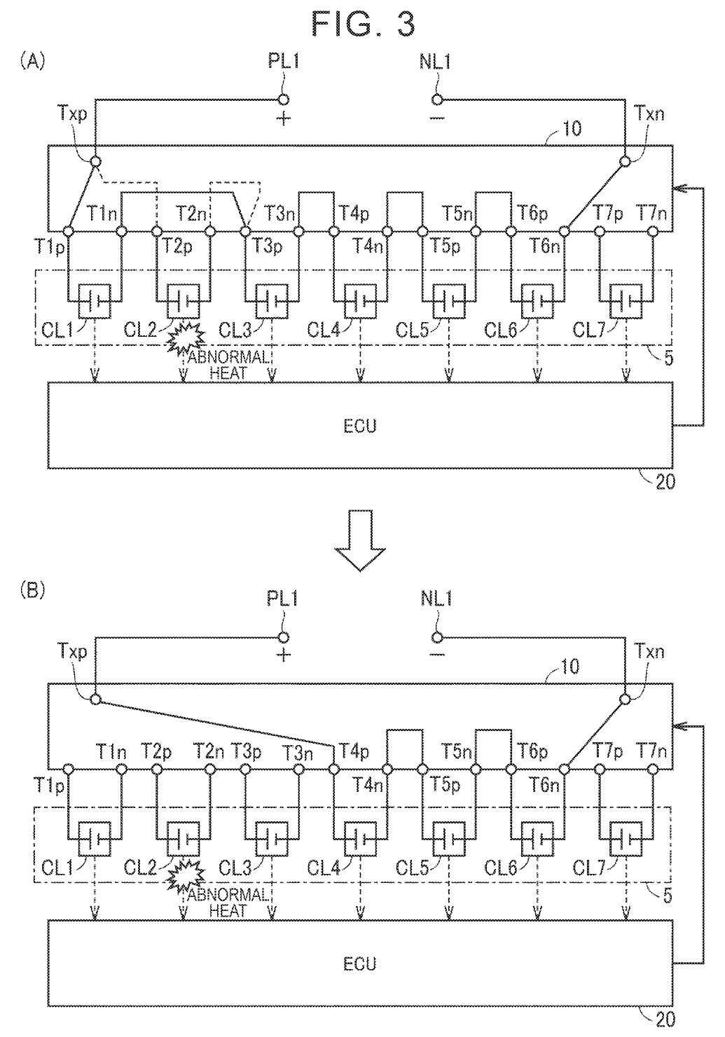

Although a configuration in which the battery cell CL2, in which a high temperature abnormality has occurred, is isolated from the power line pair PL1 and NL1 by the switching circuit 10 has been described with reference to FIG. 1, the configuration illustrated in FIG. 3 using the switching circuit 10 can be employed as well.

As a first modification, in a part (A) of FIG. 3, the ECU 20 controls the switching circuit 10 to connect the battery cell CL2, in which a high temperature abnormality has occurred, in parallel with other battery cells CL. For the other battery cells CL, unused battery cells CL other than the battery cells CL2 to CL6 can be selected. In the part (A) of FIG. 3, the battery cell CL2 and the battery cell CL1 are connected in parallel. The parallel circuit of the battery cells CL1 and CL2 is then connected in series to the serial circuit of the battery cells CL3 to CL6.

This reduces the current flowing through the battery cell CL2 by half, thereby enabling reduction in heat generation from the battery cell CL2. Deterioration due to heat generation in the battery cell CL2 can be suppressed, and consequently, the life of the battery pack 5 as a whole can be extended.

Also, connecting the unused battery cell CL1 in parallel to the battery cell CL2 with the high temperature abnormality enables the voltage of the battery pack 5 as a whole to be maintained.

Note that when the temperature of the battery cell CL2 drops to within an appropriate range, the ECU 20 can control the switching circuit 10 to isolate the battery cell CL1 from the parallel circuit. In this case, the battery cells CL1 to CL7 can be returned to their original connection state.

As a second modification, as illustrated in a part (B) of FIG. 3, the ECU 20 controls the switching circuit 10 to isolate the battery cell CL2 in which a high temperature abnormality has occurred, and the battery cells CL1 and CL3 adjacent to the battery cell CL2, from the power line pair PL1 and NL1.

In the part (B) of FIG. 3, the battery cells CL1 and CL3 that are adjacent to the battery cell CL2 that has become hot are also isolated from the power line pair PL1 and NL1, and accordingly the current flowing through all of the battery cells CL1 to CL3 becomes zero. Therefore, heat generation from the battery cells CL2 and CL3 is stopped. The heat of the battery cell CL2 is easily conducted to the battery cell CL3, the temperature of the battery cell CL2 can be reduced more quickly as compared with the arrangement in the part (B) of FIG. 1.

Note that in the second modification, the number of serial connections of the battery cells CL between the power line pair PL1 and NL1 is reduced, and accordingly the voltage of the battery pack 5 as a whole drops after a high temperature abnormality is detected. However, cooling efficiency of cooling the battery cell CL2 can be raised, and accordingly the battery cells CL1 to CL7 can be promptly returned to their original connection state.

### Second Embodiment

In the battery system, there are cases in which variance occurs among the SOCs of each of the battery cells CL as the battery cells CL1 to CL7 are repeatedly charged and discharged. In a second embodiment, a configuration in which the switching circuit 10 is used to equalize the SOC of each of the battery cells CL will be described.

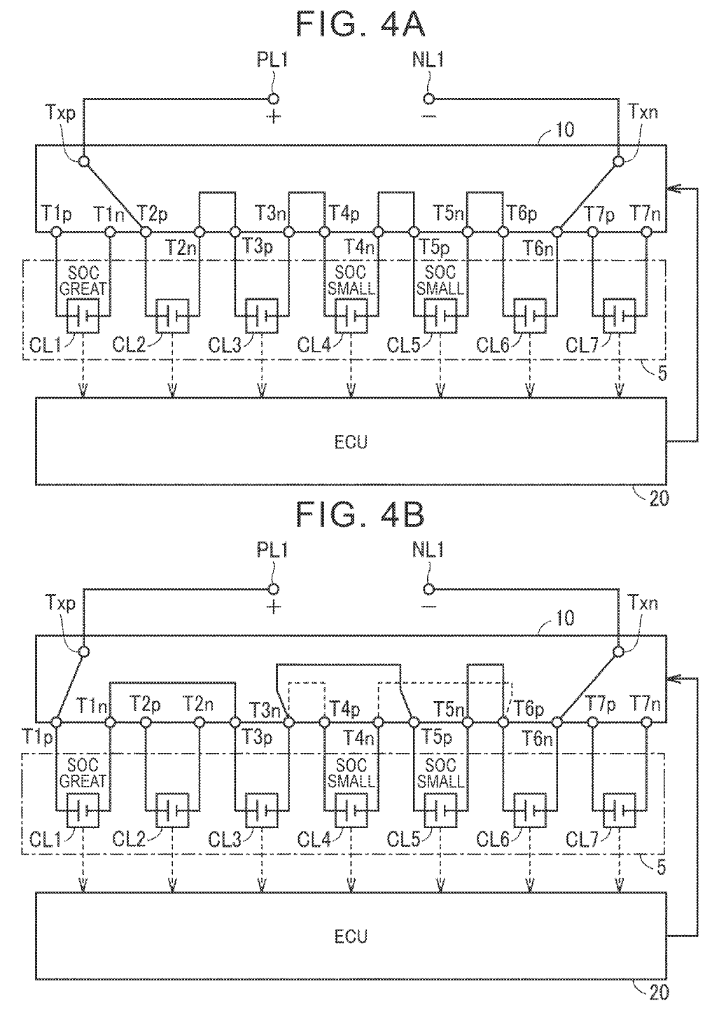

As illustrated in FIG. 4A, five battery cells CL2 to CL6 are connected in series by the switching circuit 10 between the positive power line PL1 and the negative power line NL1. That is to say, a serial circuit of the five battery cells CL2 to CL6 is connected between the positive power line PL1 and the negative power line NL1.

In this case, charging or discharging is executed collectively with respect to the battery cells CL2 to CL6. However, due to influence of capacity variance and so forth among the battery cells CL, the SOCs of the battery cells CL2 to CL6 may become non-uniform. Furthermore, difference in SOCs may be generated between the battery cells CL1 and CL7 that are in an unused state.

The ECU 20 calculates the SOC of each of the battery cells CL, based on the signals that are received from the monitoring modules of the battery cells CL1 to CL7. In FIG. 4A, the SOCs of the battery cells CL1 and CL7 in an unused state are maintained at a predetermined fully charged state. On the other hand, the SOCs of the battery cells CL4 and CL5 are lower than those of the other battery cells CL.

In this case, during the discharging in which the direct current electric power of the battery pack 5 is output to the power line pair PL1 and NL1, the ECU 20 controls the switching circuit 10 so as to reduce the discharged electric power of the battery cells CL4 and CL5 with low SOCs, and also to increase the discharged electric power of the battery cell CL1 with a high SOC.

Specifically, as illustrated in FIG. 4B, when the battery pack 5 is discharging, the ECU 20 controls the switching circuit 10 to connect the battery cell CL1 to the power line pair PL1 and NL1 instead of the battery cell CL2. Further, the ECU 20 controls the switching circuit 10 so as to connect the battery cells CL4 and CL5 in parallel. Accordingly, the serial circuit of the battery cells CL1, CL3, and CL6, and the parallel circuit of the battery cells CL4 and CL5, are connected in series between the positive power line PL1 and the negative power line NL1.

In FIG. 4B, the electric power that is stored in the battery cell CL1 that has transitioned from an unused state to a used state is output, and accordingly the SOC of the battery cell CL1 decreases. On the other hand, the current flowing through each of the battery cells CL4 and CL5 is reduced to half by being connected in parallel, and accordingly the decrease in the SOC of each of the battery cells CL becomes more gradual. As a result, as the discharge of the battery pack 5 progresses, the difference in SOCs between the battery cell CL1 and the battery cells CL4 and CL5 can be reduced.

Note that while the switching circuit 10 is configured to be controlled so as to equalize the SOCs of each of the battery cells CL when the battery pack 5 is being discharged in FIGS. 4A and 4B, the switching circuit 10 may be configured to be controlled so as to equalize the SOCs of the battery cells CL with each other when the battery pack 5 being is charged. For example, by controlling the switching circuit 10 such that the battery cells CL with great SOCs are isolated from the power line pair PL1 and NL1 or are connected in parallel with other battery cells CL, and also the battery cells CL with small SOCs are connected in series between the power line pair PL1 and NL1, the electric power that is supplied to the battery cells CL with small SOCs can be increased and the difference in SOCs among the battery cells CL can be reduced.

### Third Embodiment

In a third embodiment, operations of the switching circuit 10 in a case in which an abnormality occurs in two or more battery cells CL in the battery pack 5 will be described.

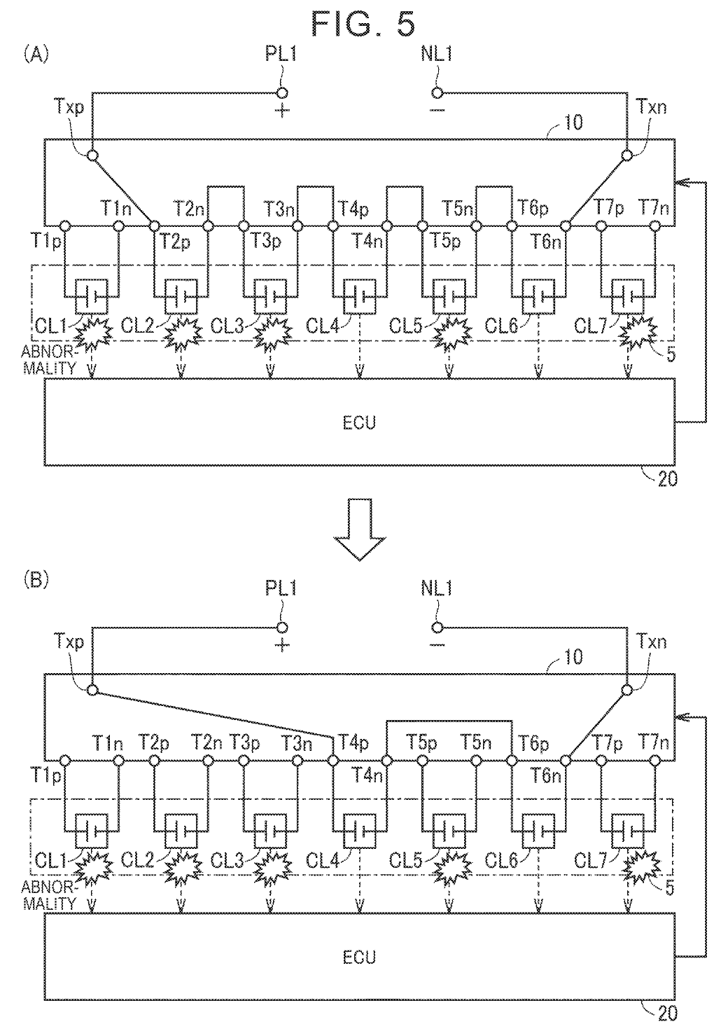

As illustrated in a part (A) of FIG. 5, five battery cells CL2 to CL6 are connected in series by the switching circuit 10 between the positive power line PL1 and the negative power line NL1. That is to say, a serial circuit of the five battery cells CL2 to CL6 is connected between the positive power line PL1 and the negative power line NL1.

A case will be assumed in which, in this state, an abnormality occurs in five battery cells CL (e.g., battery cells CL1 to CL3, CL5, and CL7). The only normal battery cells CL are the battery cells CL4 and CL6.

In this case, the ECU 20 controls the switching circuit 10 to isolate the five battery cells CL1 to CL3, CL5, and CL7, in which an abnormality has occurred, from the power line pair PL1 and NL1, and to connect just the two battery cells CL4 and CL6, which are normal, to the power line pair PL1 and NL1.

In a part (B) of FIG. 5, the ECU 20 controls the switching circuit 10 to connect the battery cells CL4 and CL5 in series. Accordingly, a serial circuit of the battery cells CL4 and CL5 is connected between the positive power line PL1 and the negative power line NL1.

In this way, although the voltage of the battery pack 5 as a whole falls in comparison with before the abnormality was detected, electric power can be supplied from the battery pack 5 to the external system. Thus, the operation of the power load that is included in the external system can be continued.

### Fourth Embodiment

In a fourth embodiment, operations of the switching circuit 10 when a serious abnormality occurs in part of the battery cells CL of the battery pack 5 will be described.

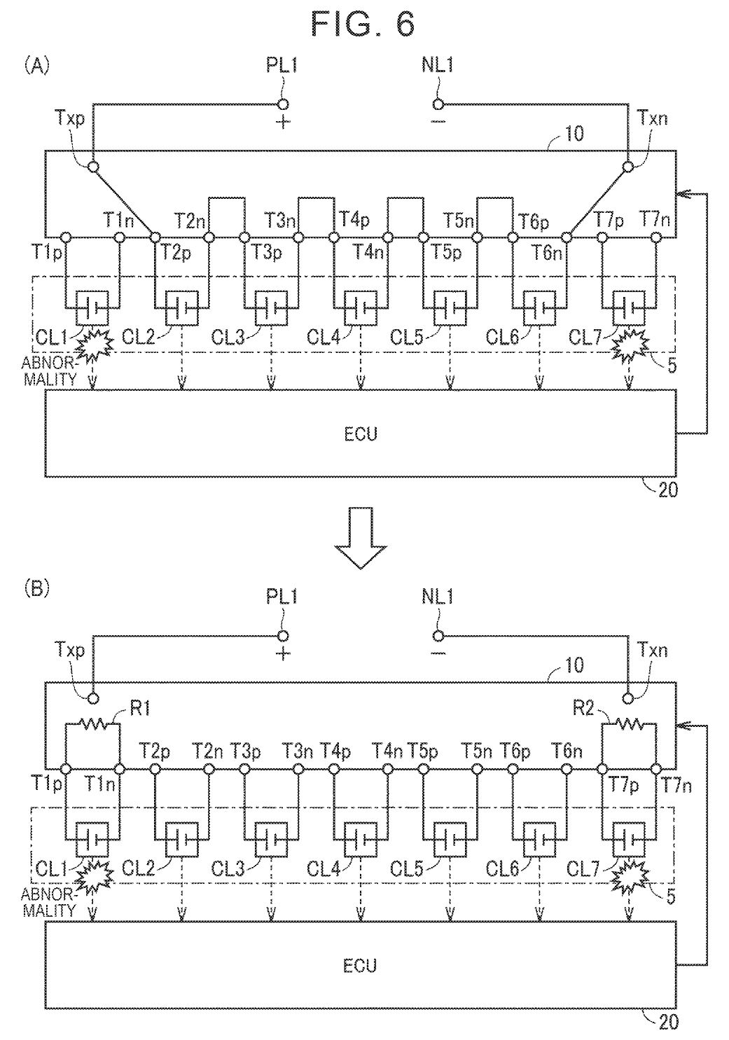

As illustrated in a part (A) of FIG. 6, five battery cells CL2 to CL6 are connected in series by the switching circuit 10 between the positive power line PL1 and the negative power line NL1. That is to say, a serial circuit of the five battery cells CL2 to CL6 is connected between the positive power line PL1 and the negative power line NL1.

A case will be assumed in which, in this state, a serious abnormality occurs in two battery cells (e.g., battery cells CL1 and CL7). In this case, the ECU 20 connects a discharge resistor R1 between the positive terminal T1p and the negative terminal T1n, and connects a discharge resistor R2 between the positive terminal T7p and the negative terminal T7n. That is to say, the discharge resistor R1 is connected between the cathode and the anode of the battery cell CL1, and the discharge resistor R2 is connected between the cathode and the anode of the battery cell CL7. The discharge resistors R1 and R2 are resistors for discharging charge stored in the battery cells CL.

This discharges the charges that are stored in the battery cells CL1 and CL7 via the discharge resistors R1 and R2, and the terminal voltages of the battery cells CL1 and CL7 decrease. Setting resistance values of the discharge resistors R1 and R2 to values that enable the discharge of the battery cell CL to be completed within several seconds after the occurrence of an abnormality is desirable. Note that the resistance values of the discharge resistors may be variable in accordance with the voltage of the corresponding battery cell CL.

Note that even during the discharging of the battery cells CL1 and CL7, the other battery cells CL2 to CL6, which are normal, can continue to be used, and accordingly exchange of electric power with the external system can be continued.

### Fifth Embodiment

In a fifth embodiment, a configuration for improving charging speed of the battery pack 5 by using the switching circuit 10 will be described.

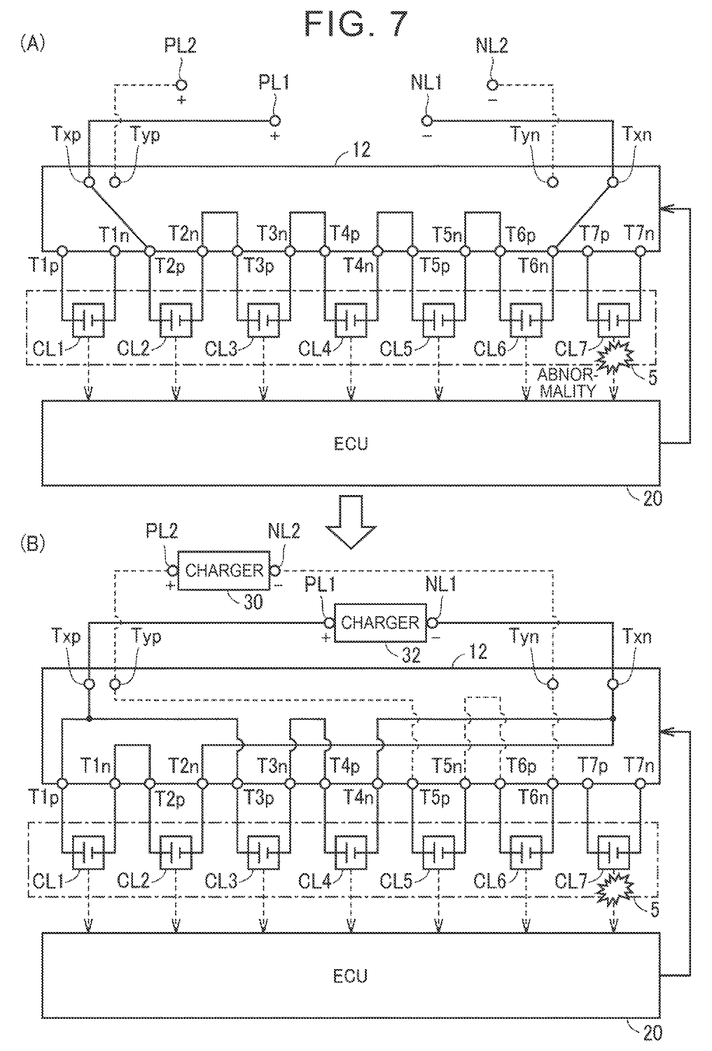

A part (A) of FIG. 7 is a diagram illustrating a schematic configuration of the battery system according to the fifth embodiment. The battery system according to the fifth embodiment differs from the battery system according to the first embodiment illustrated in the part (A) of FIG. 1 with respect to the point of including a power line pair PL2 and NL2, and the point of including a switching circuit 12 instead of the switching circuit 10.

The power line pair PL2 and NL2 exchanges direct current electric power between the battery pack 5 and the external system. The power line pair PL2 and NL2 is made up of a positive power line PL2 and a negative power line NL2. The power line pair PL1 and NL1 corresponds to an example of "first power line pair", and the power line pair PL2 and NL2 corresponds to an example of "second power line pair".

The switching circuit 12 is disposed between the battery pack 5, and the power line pair PL1 and NL1 and power line pair PL2 and NL2. The switching circuit 12 is configured to be able to switch between electrical connection and interruption with respect to the power line pair PL1 and NL1 in increments of individual battery cells CL. Also, the switching circuit 12 is configured to be able to switch between electrical connection and interruption with respect to the power line pair PL2 and NL2 in increments of individual battery cells CL.

Specifically, the switching circuit 12 includes the positive terminals T1p to T7p, the negative terminals T1n to T7n, positive terminals Txp and Typ, and negative terminals Txn and Tyn. In the same way as with the switching circuit 10, the positive terminals T1p to T7p are electrically connected to the cathodes of the battery cells CL1 to CL7, respectively. The negative terminals T1n to T7n are electrically connected to anodes of the battery cells CL1 to CL7, respectively.

The positive terminal Txp is electrically connected to the positive power line PL1. The negative terminal Txn is electrically connected to the negative power line NL1. The positive terminal Typ is electrically connected to the positive power line PL2. The negative terminal Tyn is electrically connected to the negative power line NL2.

Although omitted from illustration, the switching circuit 12 includes multiple switches SW, in the same way as the switching circuit 10 illustrated in FIG. 2. The switches SW include, in addition to the switch groups SG1, SG2, and SG3 that are the same as those in FIG. 2, a switch group SG4 including multiple switches SW that are respectively connected between the positive terminal Typ and the positive terminals T1p to T7p, and a switch group SG5 including multiple switches SW that are respectively connected between the negative terminal Tyn and the negative terminals T1n to T7n.

In the example of the part (A) of FIG. 7, the ECU 20 controls the switching circuit 12 so as to connect the five battery cells CL2 to CL6 in series between the positive power line PL1 and the negative power line NL1. This enables direct current electric power to be exchanged between the serial circuit of the battery cells CL2 to CL6 and the external system.

When charging the battery pack 5, the ECU 20 controls the switching circuit 12 to connect battery cells CL that are part of the battery cells CL between the power line pair PL1 and NL1, and to connect the other battery cells CL, other than this part of the battery cells CL, between the power line pair PL2 and NL2.

In the part (A) of FIG. 7, a case is assumed in which charging is performed with respect to the battery cells CL1 to CL6, excluding the battery cell CL7 in which an abnormality has been detected. In this case, as illustrated in a part (B) of FIG. 7, the ECU 20 connects the battery cells CL1 to CL4 between the power line pair PL1 and NL1, and connects the battery cells CL5 and CL6 between the power line pair PL2 and NL2.

The ECU 20 further controls the switching circuit 12 to connect in parallel the serial circuit of the battery cells CL1 and CL2 and the serial circuit of the battery cells CL3 and CL4 between the power line pair PL1 and NL1.

A charger 32 is connected between the power line pair PL1 and NL1. A charger 30 is connected between the power line pair PL2 and NL2. Output electric power of the charger 32 is supplied to the series-parallel circuit of the battery cells CL1 to CL4, via the power line pair PL1 and NL1. The output electric power of the charger 30 is supplied to the serial circuit of the battery cells CL5 and CL6 via the power line pair PL2 and NL2.

This enables the charging current that is supplied to each of the battery cells CL to be increased, as compared to a configuration in which electric power is supplied from the charger 30 to a serial circuit of the battery cells CL1 to CL6. Accordingly, the charging speed of the battery cells CL can be increased.

Specifically, in a configuration in which the charger 30 charges a serial circuit of the battery cells CL1 to CL6, the magnitude of the charging current of each of the battery cells CL is equal to the output electric power of the charger 30 divided by the total voltage of the six battery cells CL. On the other hand, in the example of the part (B) of FIG. 7, the serial circuit of the battery cells CL1 and CL2 and the serial circuit of the battery cells CL3 and CL4 are connected in parallel, and accordingly the magnitude of the charging current of each of the battery cells CL is equal to the output electric power of the charger 30 divided by the total voltage of the two battery cells CL and the number of parallel connections, which is two, and accordingly the charging current can be increased.

Also, connecting the battery cells CL5 and CL6 to a separate charger 30 enables the battery cells CL5 and CL6 to be supplied with the same charging current as that which is supplied to the battery cells CL1 to CL4. As a result, the charging time of the battery pack 5 can be reduced.

Note that the connection state of the battery cells CL that are connected to each of the chargers 30 and 32 is not limited to the configuration illustrated in the part (B) of FIG. 7. The connection state of the battery cells CL can be selected as appropriate in accordance with the capacity of the chargers 30 and 32, the terminal voltage of the battery cells CL, the capacities of the power line pair PL1 and NL1 and the power line pair PL2 and NL2, and so forth.

The embodiment disclosed herein should be considered to be exemplary in all respects and not restrictive. The scope of the present disclosure is indicated by the claims rather than the description of the embodiment described above, and it is intended that all changes within the meaning and scope equivalent to the claims are included. Also, the technical elements described in the present specification and the drawings exhibit technical utility either alone or in various combinations, and are not limited to the combinations described in the claims at the time of filing.

What is claimed is:

1. A battery system that is equipped with N battery cells, in which N is an integer of 3 or more, the battery system comprising:
a first power line pair for exchanging direct current electric power between the battery system and an external system;
a switching circuit that is disposed between the N battery cells and the first power line pair, and that is configured to switch between electrical connection and interruption with respect to the first power line pair, in increments of individual battery cells; and
a control device that monitors a state of each of the N battery cells and controls the switching circuit based on monitoring results.

2. The battery system according to claim 1, wherein, in a state in which M battery cells out of the N battery cells are connected between the first power line pair, in which M is an integer less than N, and when an abnormality is detected in a first battery cell out of the M battery cells, the control device executes one of
a) controlling the switching circuit so as to isolate the first battery cell from the first power line pair and connect a second battery cell other than the M battery cells to the first power line pair,
b) controlling the switching circuit so as to connect the second battery cell in parallel with the first battery cell, and
c) controlling the switching circuit so as to isolate the first battery cell and a third battery cell that is adjacent to the first battery cell from the first power line pair.

3. The battery system according to claim 1, wherein, when variance in State Of Charge (SOC) is detected among the N battery cells, the control device controls the switching circuit such that, when discharging the battery system, first and second battery cells with lower SOCs among the N battery cells are connected in parallel, and also a third battery cell with a higher SOC is connected in series to a parallel circuit of the first and the second battery cells.

4. The battery system according to claim 1, wherein:
the switching circuit includes a discharge resistor; and
when an abnormality is detected in a first battery cell among the N battery cells, the control device controls the switching circuit so as to isolate the first battery cell from the first power line pair, and also to connect the discharge resistor between a cathode and an anode of the first battery cell.

5. The battery system according to claim 1, further comprising a second power line pair for exchanging direct current electric power between the battery system and the external system, in which M is an integer equal to or smaller than N, and L is an integer of 2 or more and smaller than M, wherein:
the switching circuit is further configured to switch between electrical connection and interruption with respect to the second power line pair, in increments of individual battery cells;
the external system includes
a first charger that is connected to the first power line pair, and
a second charger that is connected to the second power line pair; and
when charging M battery cells out of the N battery cells, the control device controls the switching circuit such that L battery cells out of the M battery cells are connected between the first power line pair, and also M − L battery cells are connected between the second power line pair.
